(19) United States
(12) Patent Application Publication
(10) Pub. No.: US 2007/0283279 A1
(43) Pub. Date: Dec. 6, 2007

(54) System For Customizing Outlook

(76) Inventor: Stephen Daryl Barnes, Wanchai (CN)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 10/588,867

(22) PCT Filed: Feb. 9, 2005
(86) PCT No.: PCT/IB05/00312

§ 371 Date: May 11, 2007

(30) Foreign Application Priority Data
Feb. 10, 2004 (AU) 2004900608

(51) Int. Cl. G06F 3/00; G06F 3/048

(52) U.S. Cl. 715/752; 715/845

(57) ABSTRACT

A COMM Addin for Microsoft outlook, the COMM Addin adding a plurality of menu buttons to at least one page of Microsoft outlook viewable on a users screen, the menu buttons operable by the user, such that when the user receives a mail item in the users inbox operation of one button enables the user to reply to the mail item, forward the mail item, or create a new item entry and the mail item is respectively copied to the reply, forwarded message or new item entry, and further wherein the mail item is removed from the inbox.

### FIELD OF THE INVENTION

The present invention is related to an improved methodology for using Microsoft Outlook and in particular a system for customising Outlook to enable this methodology.

### BACKGROUND OF THE INVENTION

A counter-intuitive electronic workplace organizational culture has emerged in direct response to the challenges posed by the present state of workplace organizational methodologies. Microsoft OUTLOOK is the single most prevalent desktop personal organizational software found in the workplace today but most people in any given workplace have been left to their own devices to best organize themselves in the administration of their personal daily work. No system common to all has emerged. That there is no universality in personal organizational practices whilst working on the potential/actual networked platform which Microsoft OUTLOOK represents is actually defeating the essential productivity aims for which such software was developed in the first place. Statistics show that IT has not increased overall workplace productivity for the average office worker. It has simply created more work for them.

The majority of work activities emanate from various electronic communications, whether they be emails, faxes or PDA's for example. The challenge is to find a system to hold all this together, to allow easy recall of data and to provide peace of mind that all is organised in one place to relieve the user of the mind clutter caused by managing all of these communications and the intricacy of their content from a mere list.

### OBJECT OF THE INVENTION

It is an object of the present invention to customise Microsoft Outlook to enable a user to increase productivity and organisation of their work.

### SUMMARY OF THE INVENTION

With the above object in mind the present invention provides a system to configure a user's email program, such as Microsoft Outlook wherein at least one toolbar of the user's email program is modified to provide said user with a plurality of buttons, said buttons allowing said user to process each incoming email by dealing with the email immediately, scheduling said email into said user's diary, delegating said email to another person or deleting said email.

In a further aspect the present invention provides a system to configure a user's email program wherein at least one toolbar of said user's email program is modified to provide said user with a plurality of buttons, said buttons enabling said user to select different productivity principles related to each of said buttons, and work is then scheduled onto said users personal workload depending on the said productivity principle selected.

In another aspect the present invention provides a COMM Addin for Microsoft outlook, said COMM Addin adding a plurality of menu buttons to at least one page of Microsoft outlook viewable on a users screen, said menu buttons operable by said user, such that when said user receives a mail item in said users inbox operation of one said button enables said user to reply to the mail item, forward the mail item, or create a new item entry and said mail item is respectively copied to said reply, forwarded message or new item entry, and further wherein said mail item is removed from said inbox.

In still another aspect the present invention provides a system for customizing Microsoft outlook including the addition of a plurality of menu buttons to at least one page of Microsoft outlook viewable on a users screen, said menu buttons operable by said user, such that when said user receives a mail item in said users inbox operation of one said button enables said user to reply to the mail item, forward the mail item, or create a new item entry and said mail item is respectively copied to said reply, forwarded message or new item entry, and further wherein said mail item is removed from said inbox.

### BRIEF DESCRIPTION OF THE DRAWINGS

FIGS. 1 to 18 show flow diagrams illustrating the flow and actions of the preferred implementation of the present invention.

FIG. 19 shows a table of component and class names which may be referred to in recreating the preferred embodiment of the present invention.

FIGS. 20A to 20T show a reference table which may be used in the recreating of the preferred embodiment by a programmer.

FIGS. 21 to 25 illustrate sample screen shots of the preferred embodiment of the present invention.

### DESCRIPTION OF PREFERRED EMBODIMENT

The present system seeks to provide a means by which each email received by a user is handled once and a user's work environment is optimised. This is based on intellectualizing the work emanating from each individual email at the time it is first handled by a user, proactively scheduling to undertake the work resulting from each email, gathering together the various electronic resources to undertake that work at the same time as the work is scheduled onto the user's personal workload.

Work may be defined as Interactions with others which results in: (a) activities involving face-to-face time in meetings and appointments; (b) activities involving work output with a deadline; (c) activity involving work output without a deadline; and (d) mental activity which is related to ones work.

The arrangement that the present system seeks to implement is the idea that each email is handled once, and one of four actions is applied to each email received. These four actions can be:

Deal With It Now—utilizing the email ‘Reply’, ‘Reply All’ and ‘Forward’ features—whereby the person attends to the work immediately, after which, at the users option, the email can either be deleted, filed in a folder named ‘Done’ or left in the Inbox for further action.

Decide What To Do With It—utilizing the a combination of options—whereby the user chooses to proactively schedule and/or organize the work by use of functionality available within Microsoft OUTLOOK. After applying this action to an email the next step is to use the custom features provided with the present system to gather together other electronic resources from the computer or network so that when the time comes to actually undertake the work, all that is required is on hand and readied for use.

Delegate It—utilizing the email ‘Forward’ and ‘Assign Task’ features—whereby the user elects to give the work to another person to do. The email can either be deleted, filed in a folder named ‘Done’ or left in the Inbox for further action.

Delete It—assimilate the work involved and then delete the email from the system. In the applicants preferred implementation of this present invention the word ‘Delete’ has been replaced with the word ‘Ditch’. Whether the label ‘Ditch’ or ‘Delete’ is selected can be dependent on implementation and the market for which it is intended, but the functionality remains the same.

These four actions serve the purpose of applying productivity principles achieved with the present invention. It also ‘clears’ the user's Inbox of email and illustrates that all work in hand has been considered, scheduled for action and organized for maximum personal productivity purposes.

At the end of each working session the user may also elect to apply one of the four actions to each item in their Sent Items folder. This can empower intuitive filing possibilities and management of work due back to the user from others which has been issued throughout the working session.

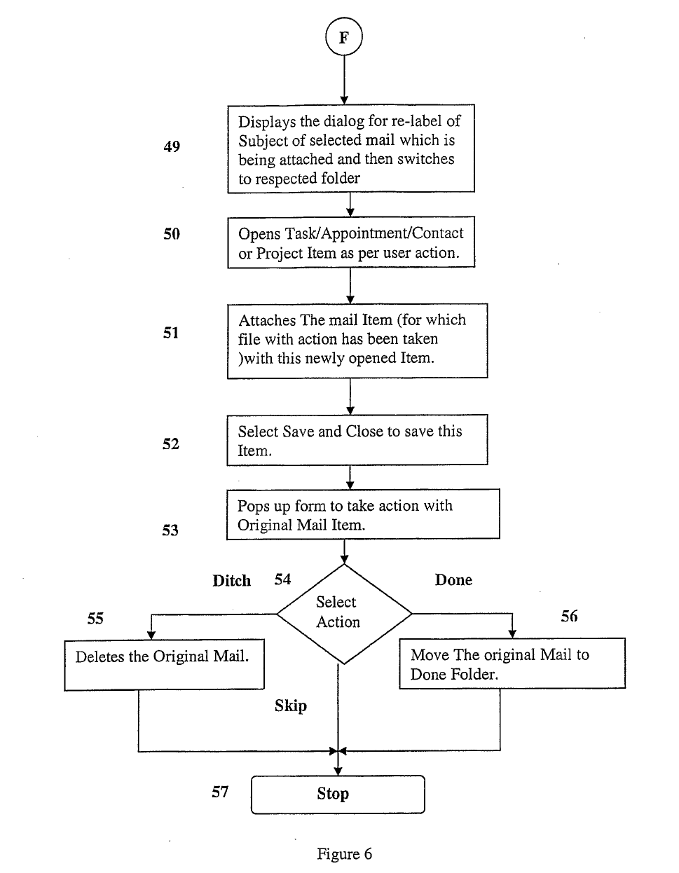

Whilst not all work is received by email the system can handle such work. By using Contacts and making a Projects folder (containing Contact items), all email, task and calendar activities in relation to people and projects are related for ease of activities audit. Three specific features in the Contacts and Projects folders enable this: Send An Email, Schedule An Appointment, Create A Task—see FIG. 6. When using these three features, the system utilises the custom features provided with Outlook to gather together other electronic resources from the computer or network so that when the time comes to actually undertake the work, all that is required is on hand and readied for use.

To best enable the above steps the present system customises Outlook as detailed herein. The user's Outlook may be configured using an application or macro that can be provided to the user. In essence this application loads all of the functionality making up the totality of the organizational system.

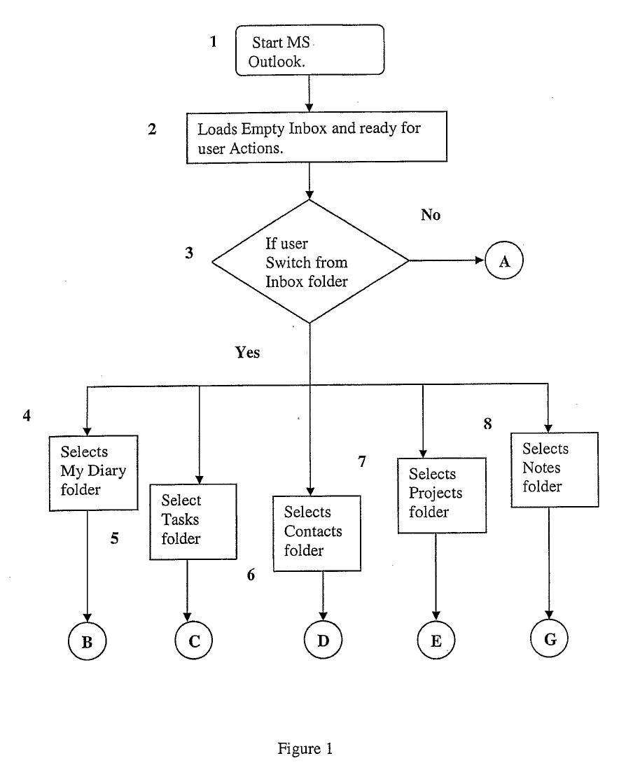

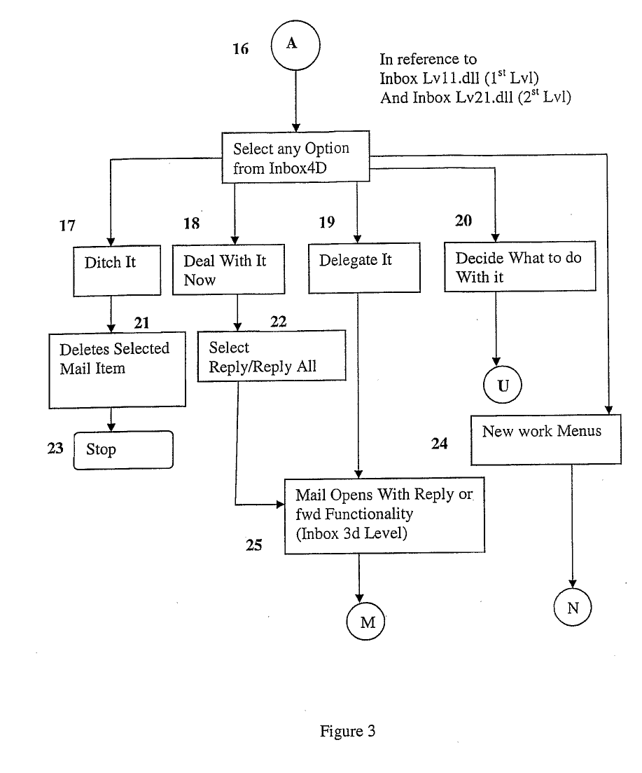

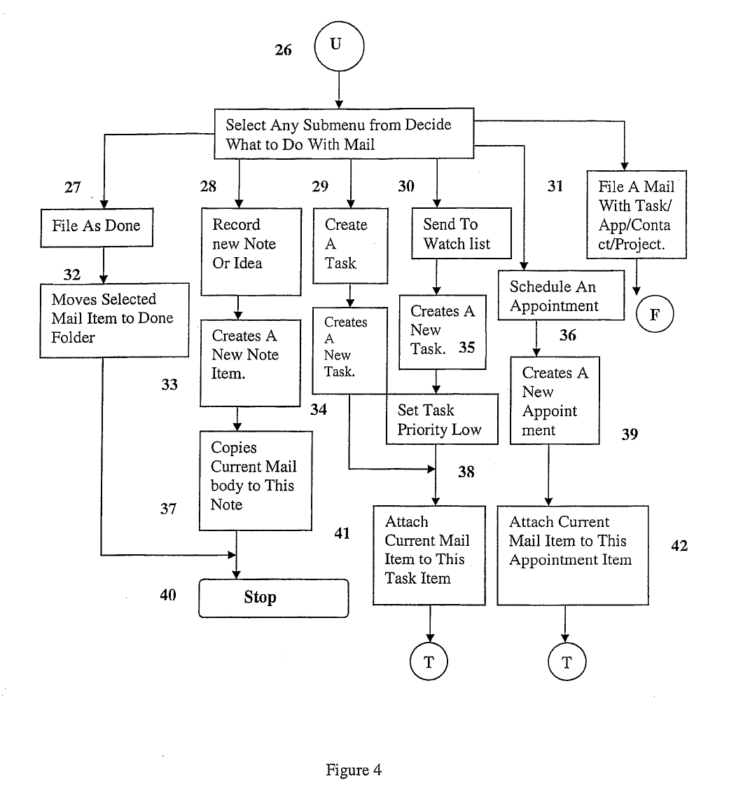

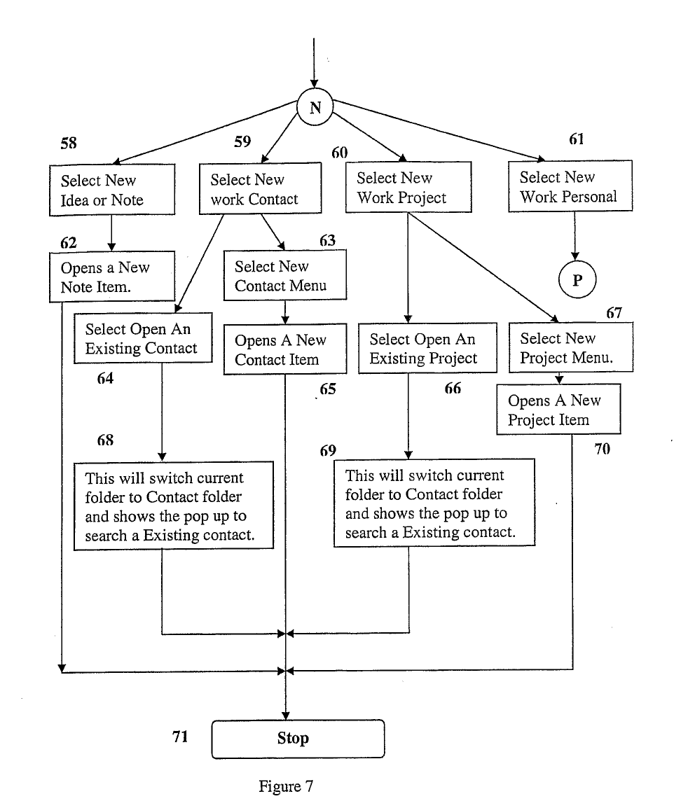

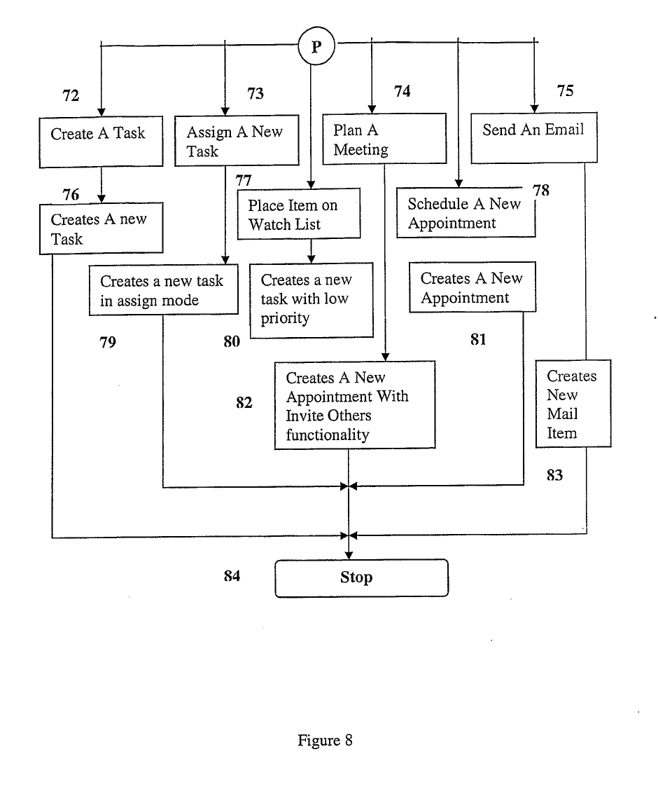

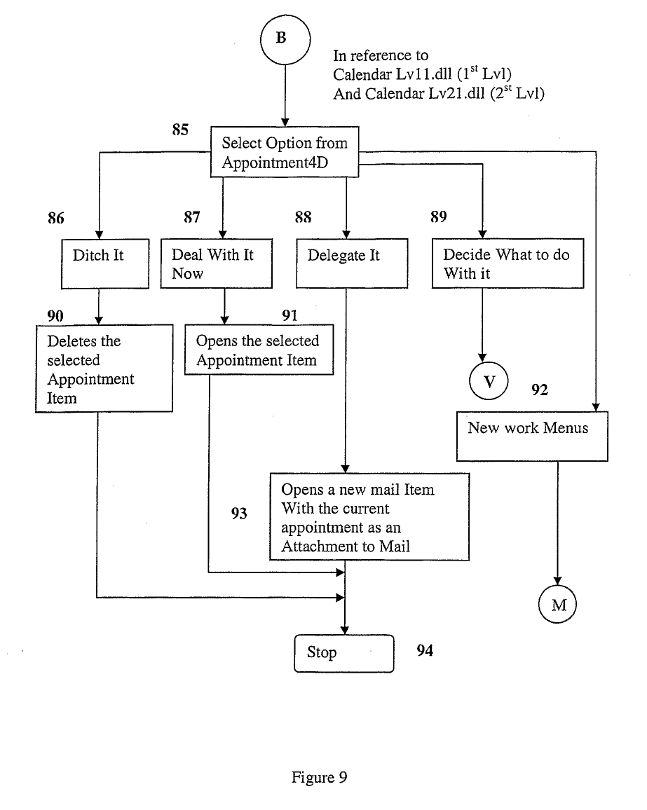

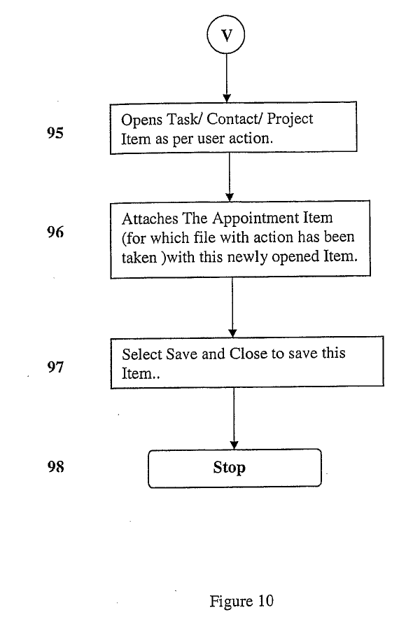

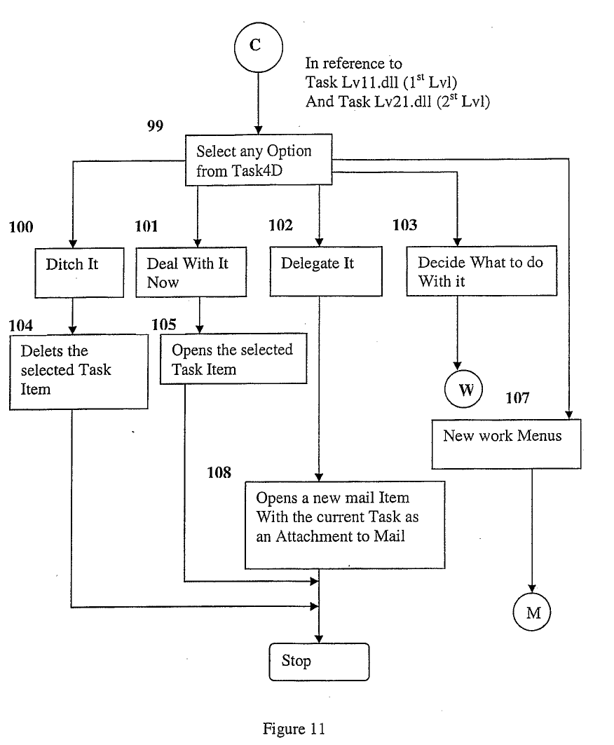

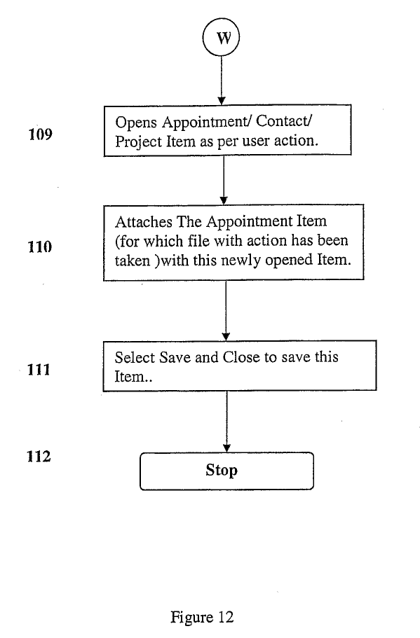

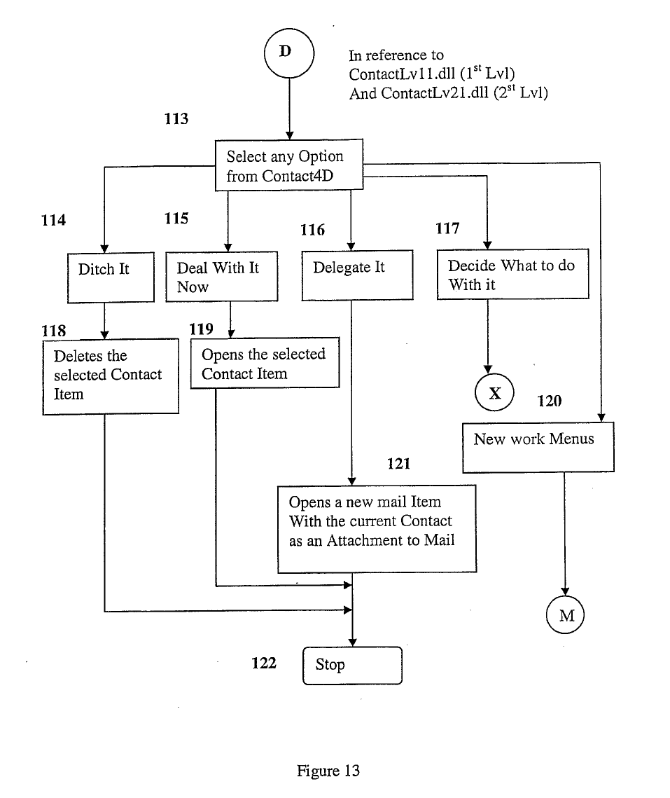

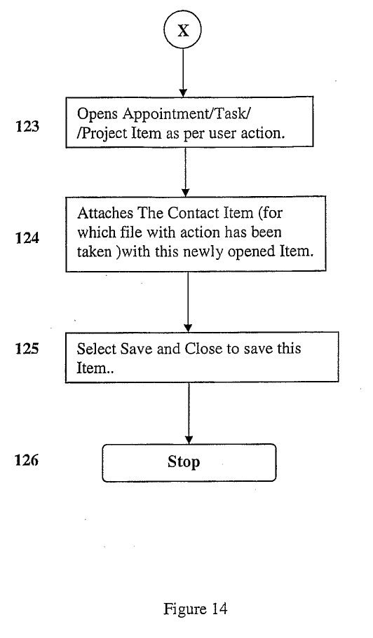

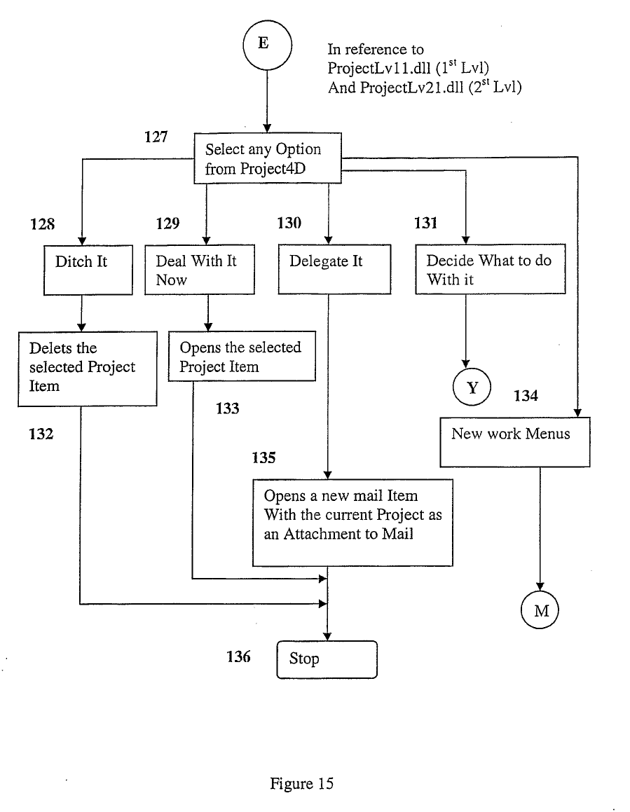

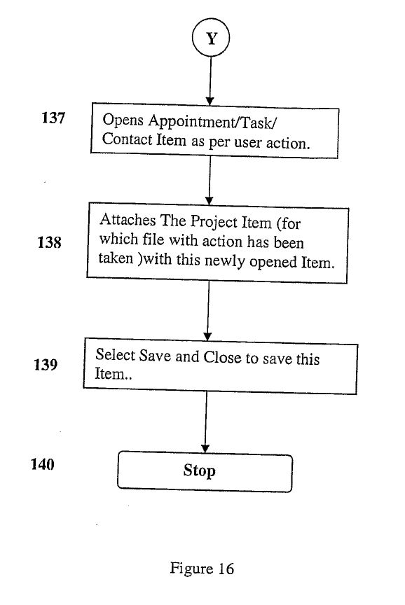

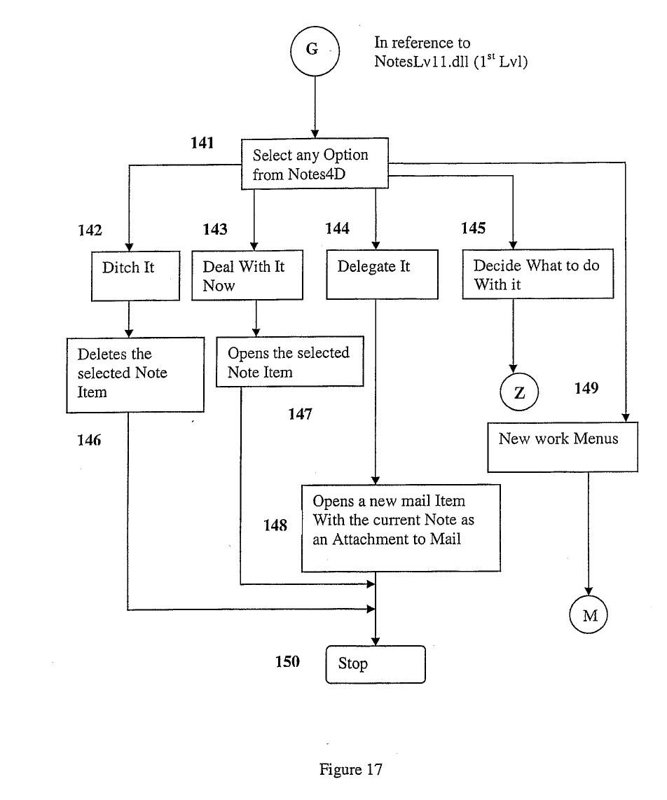

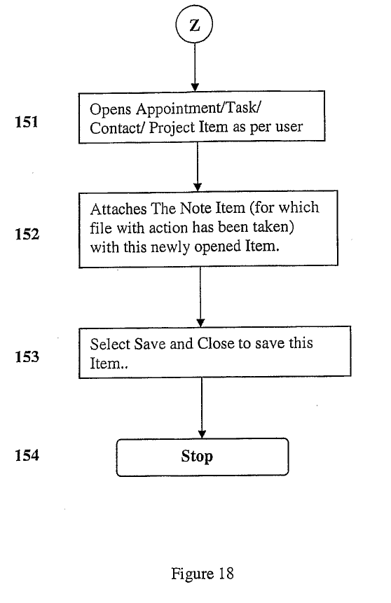

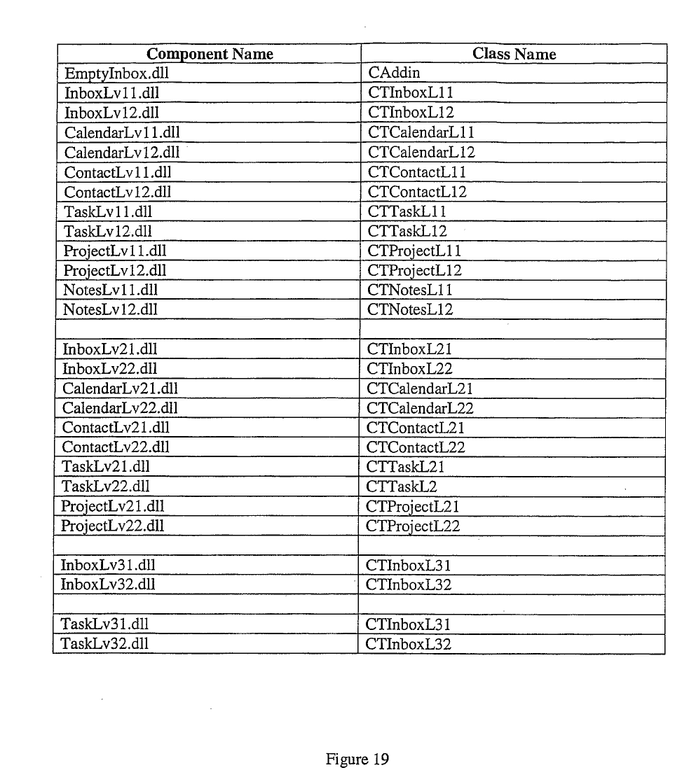

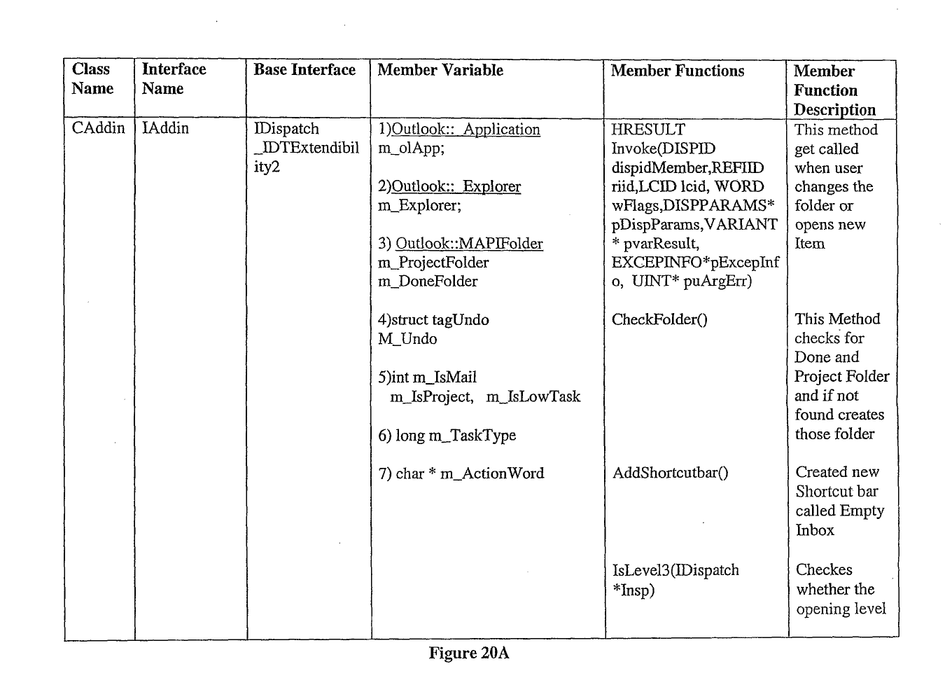

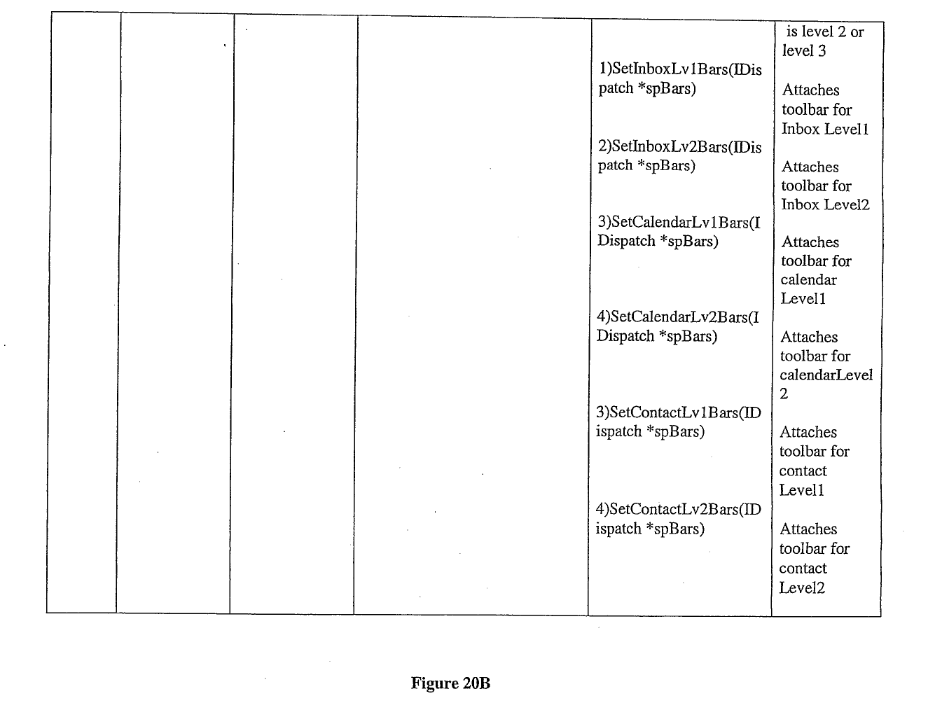

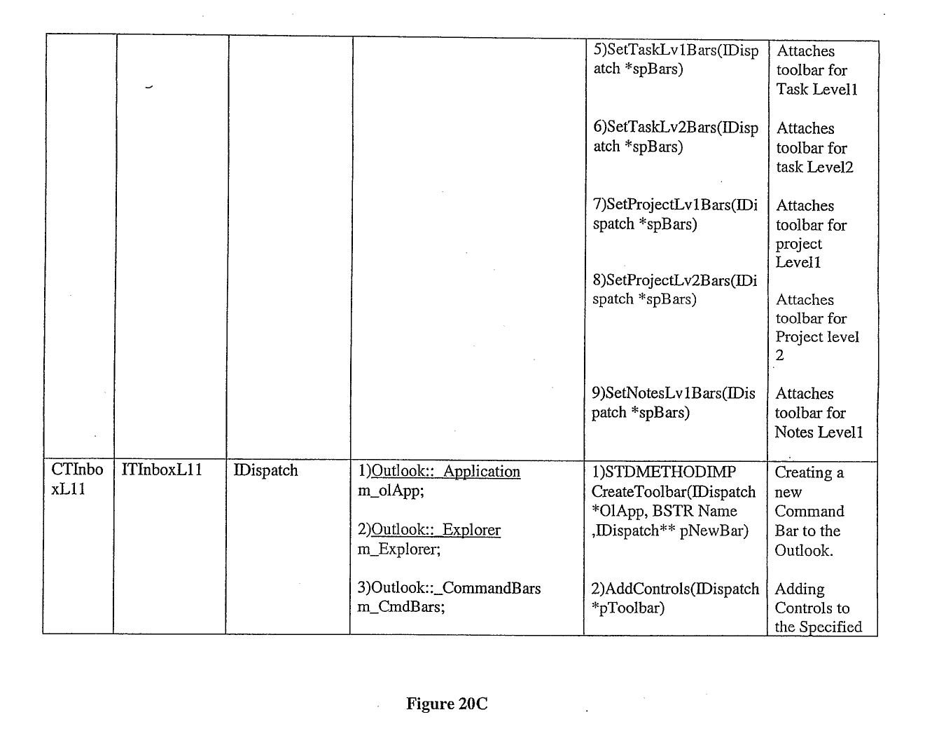

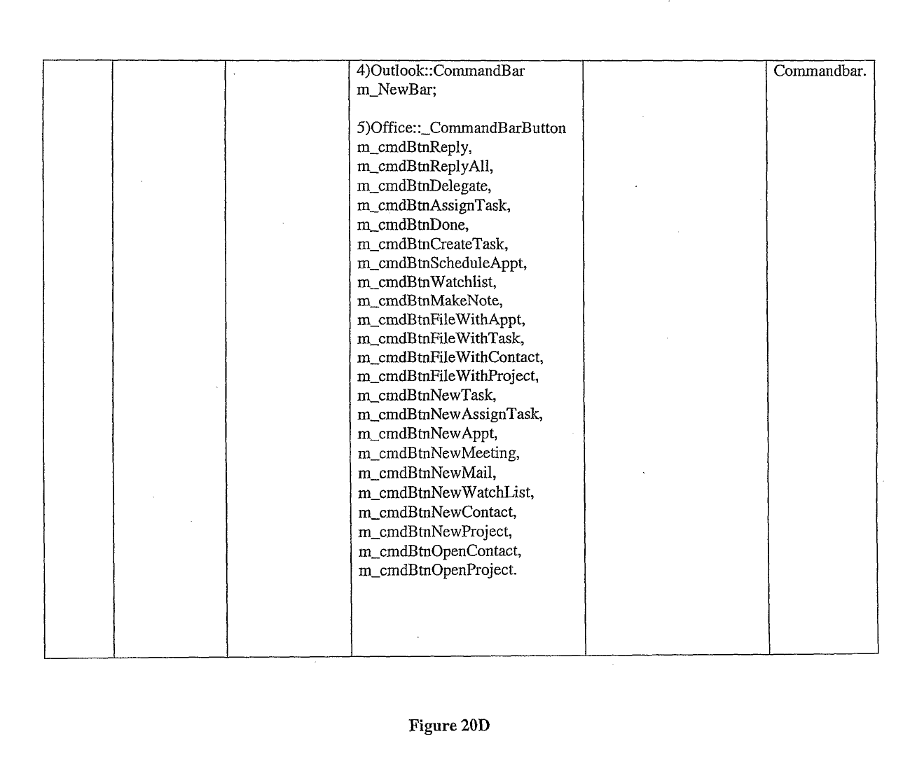

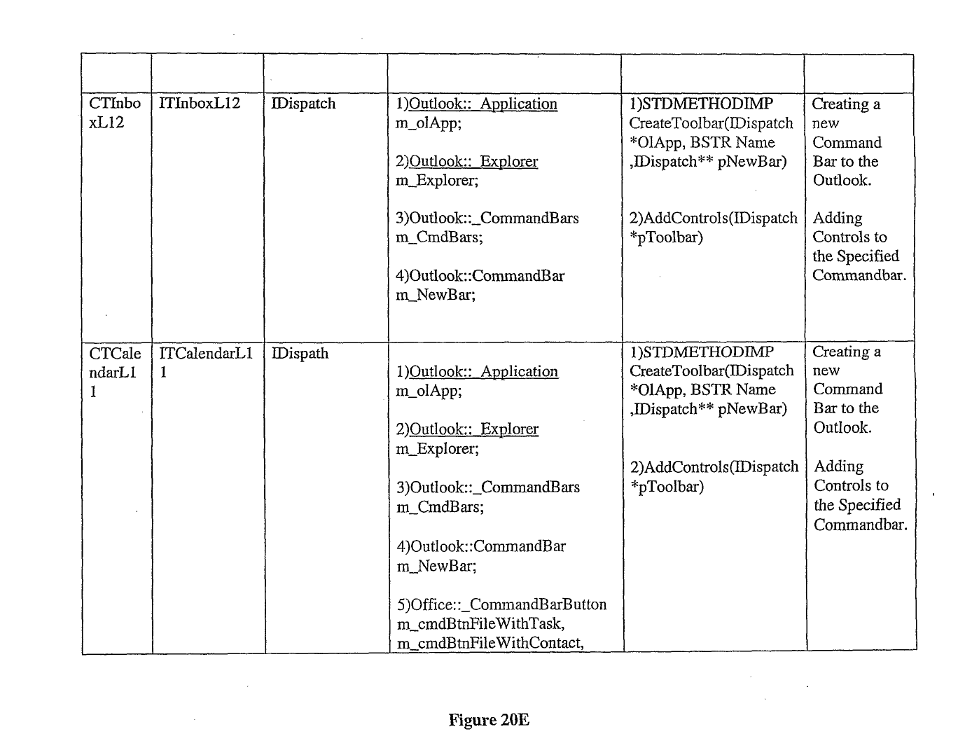

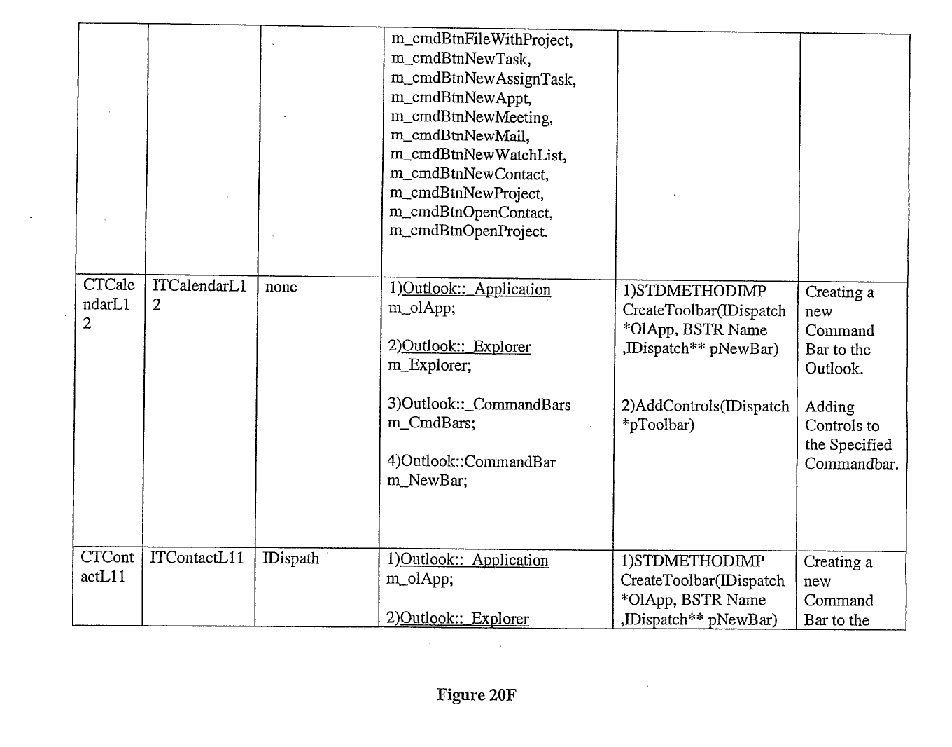

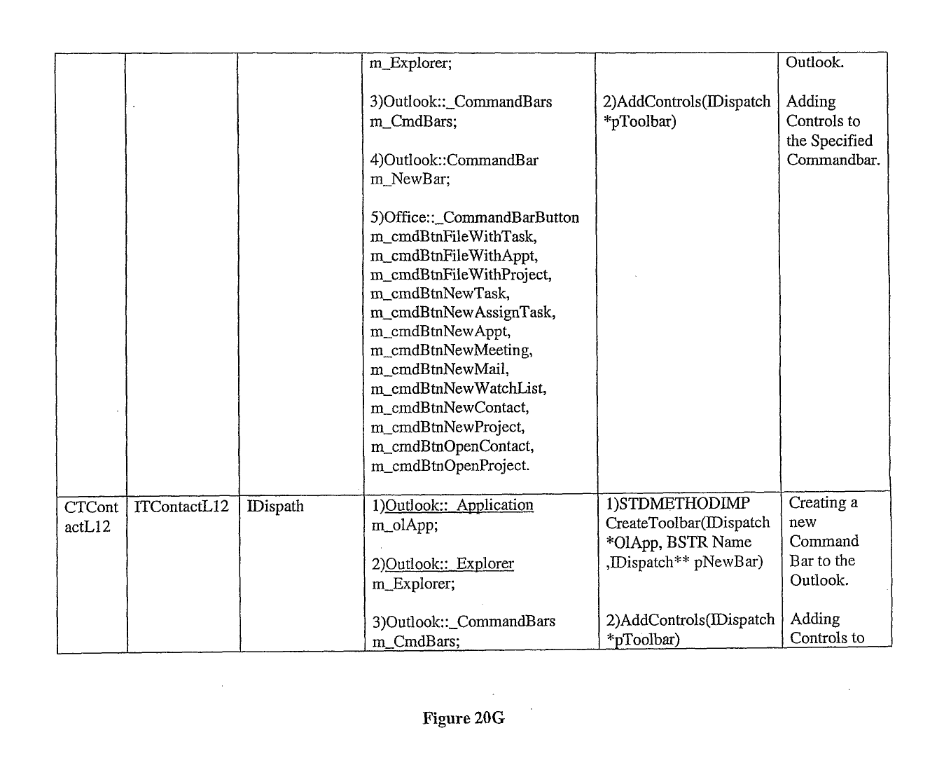

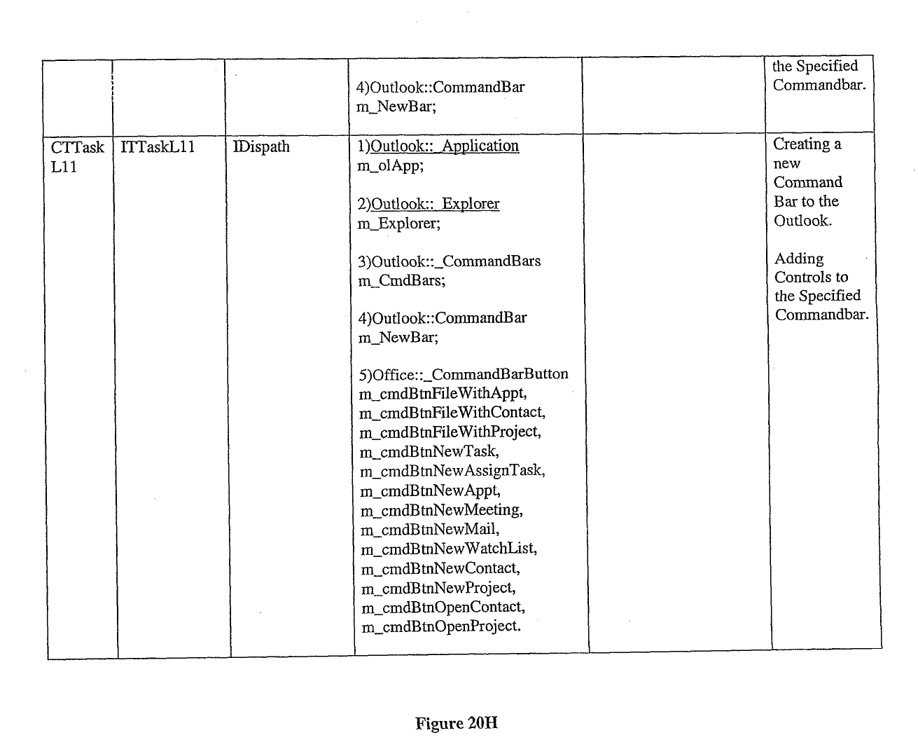

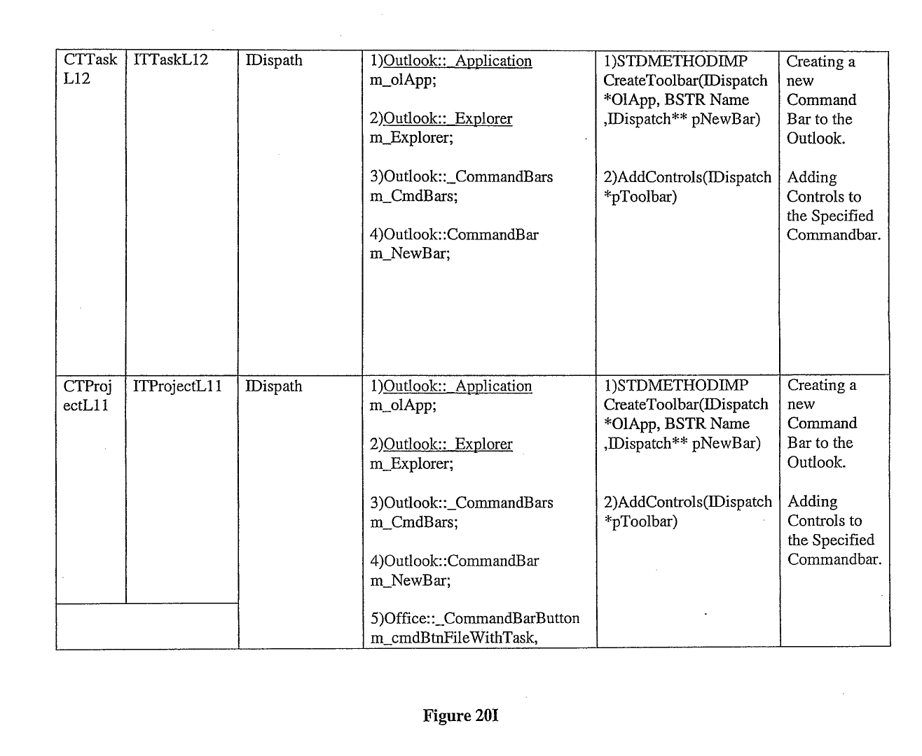

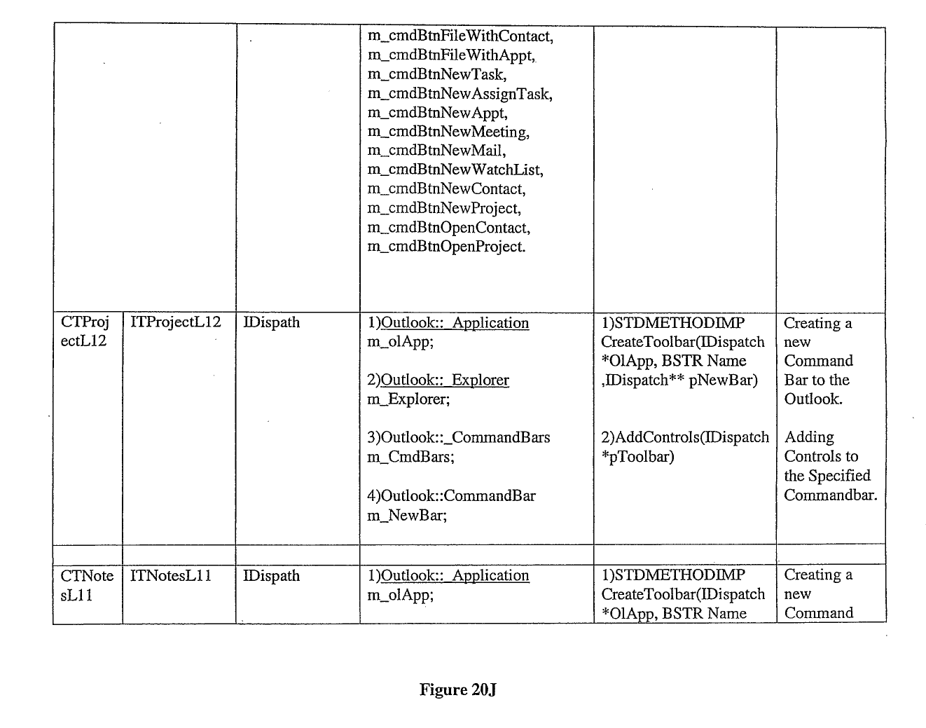

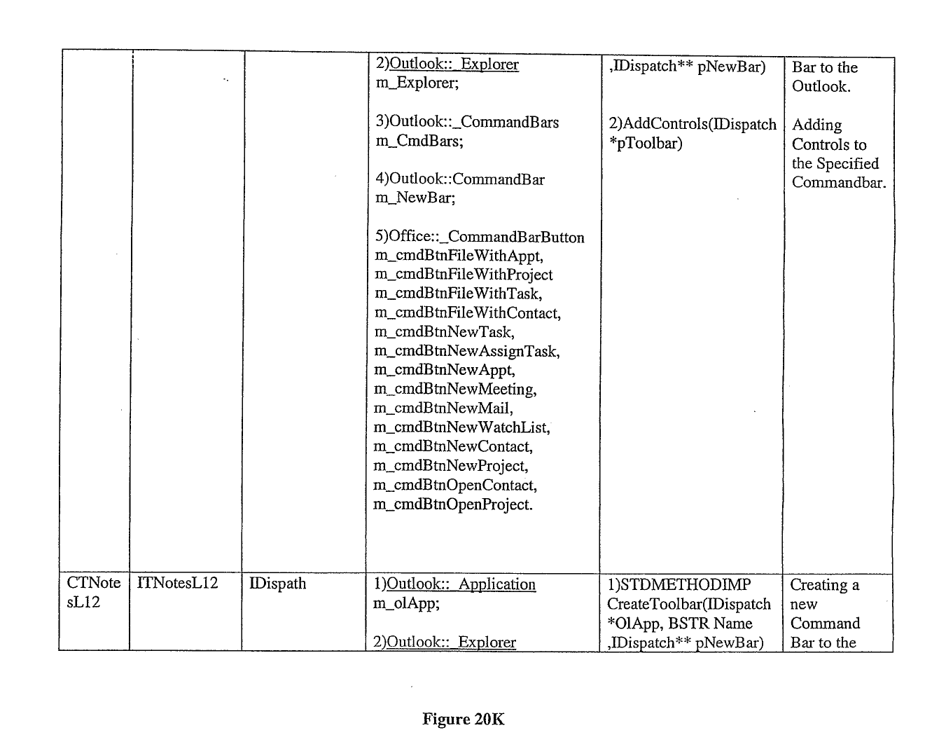

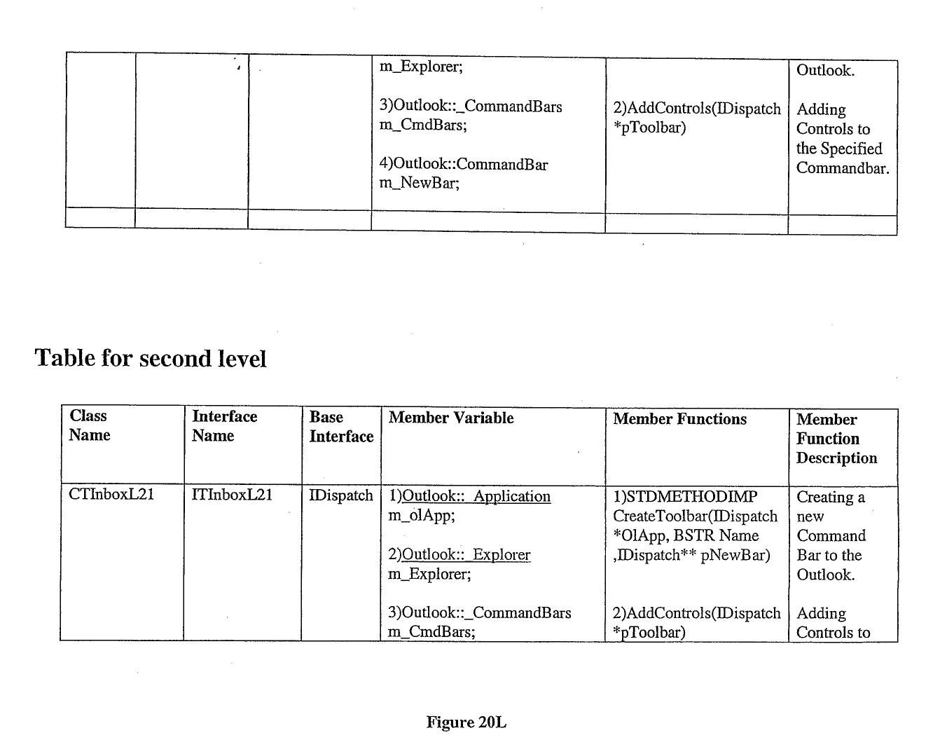

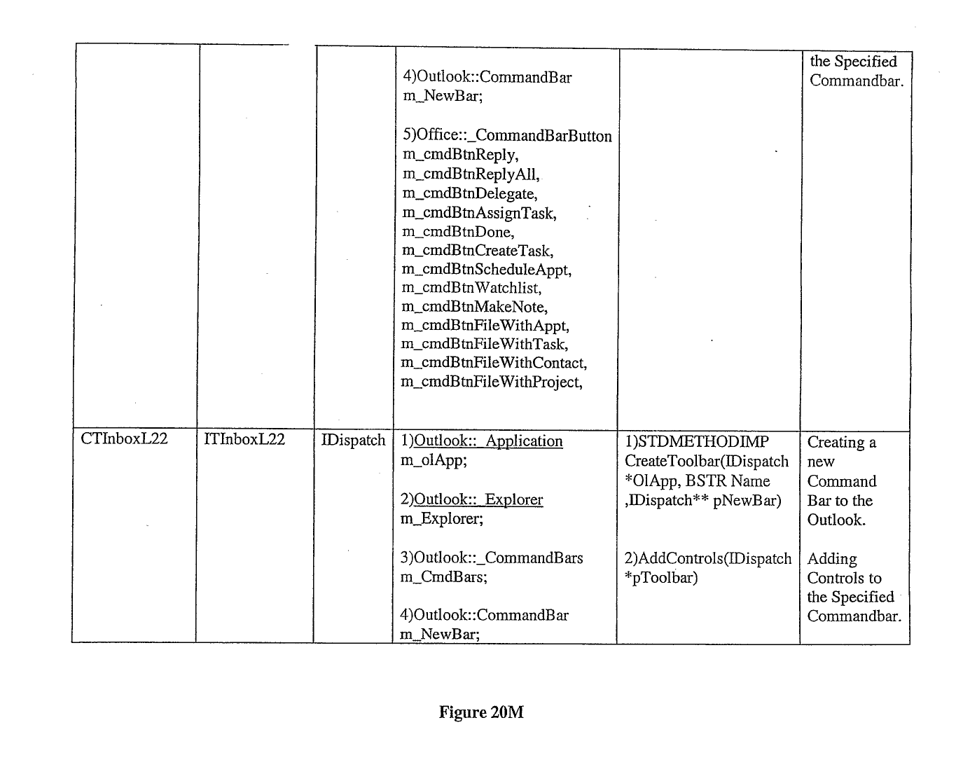

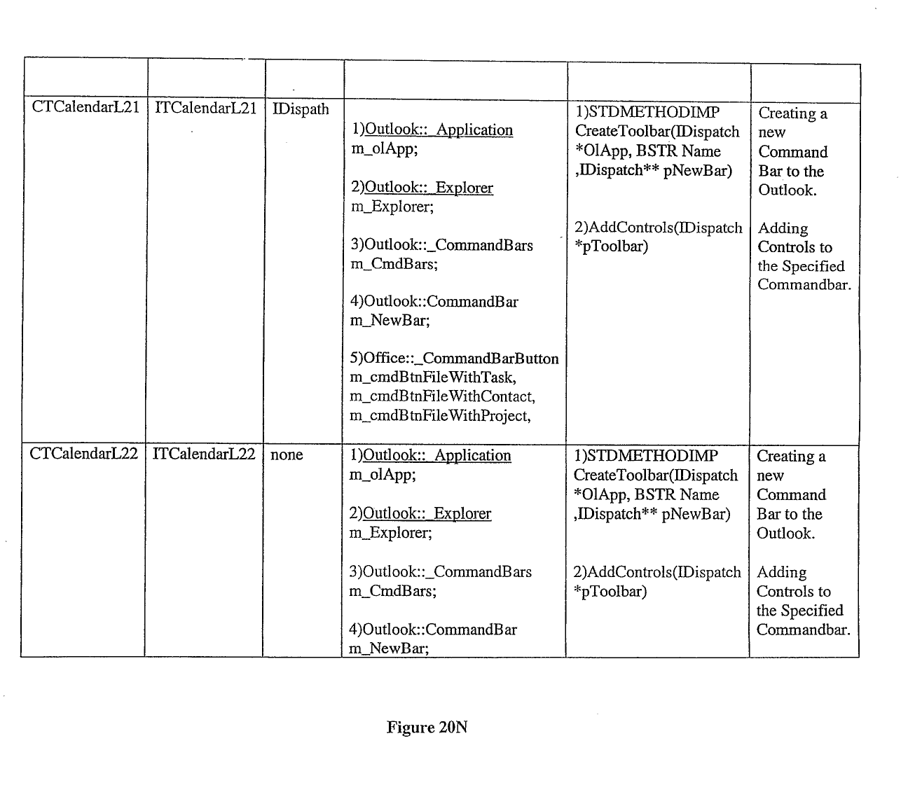

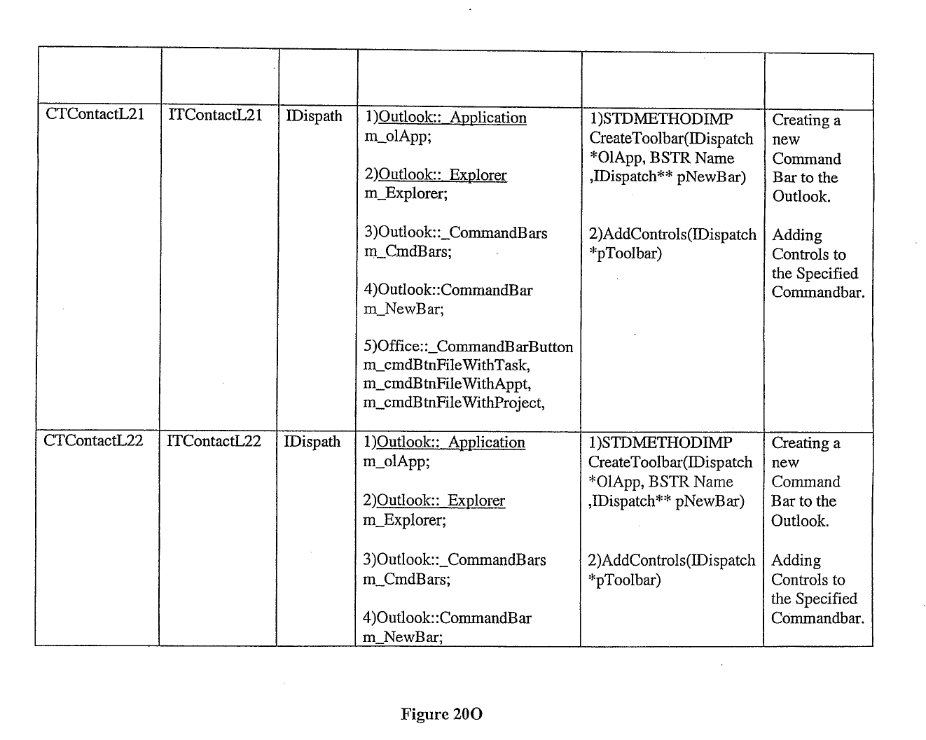

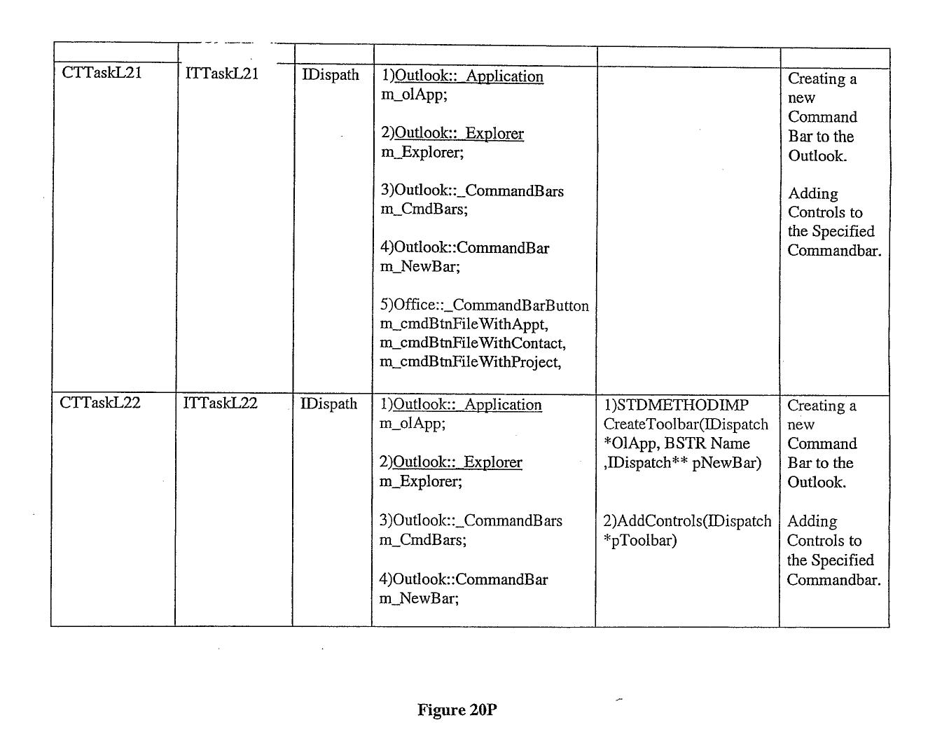

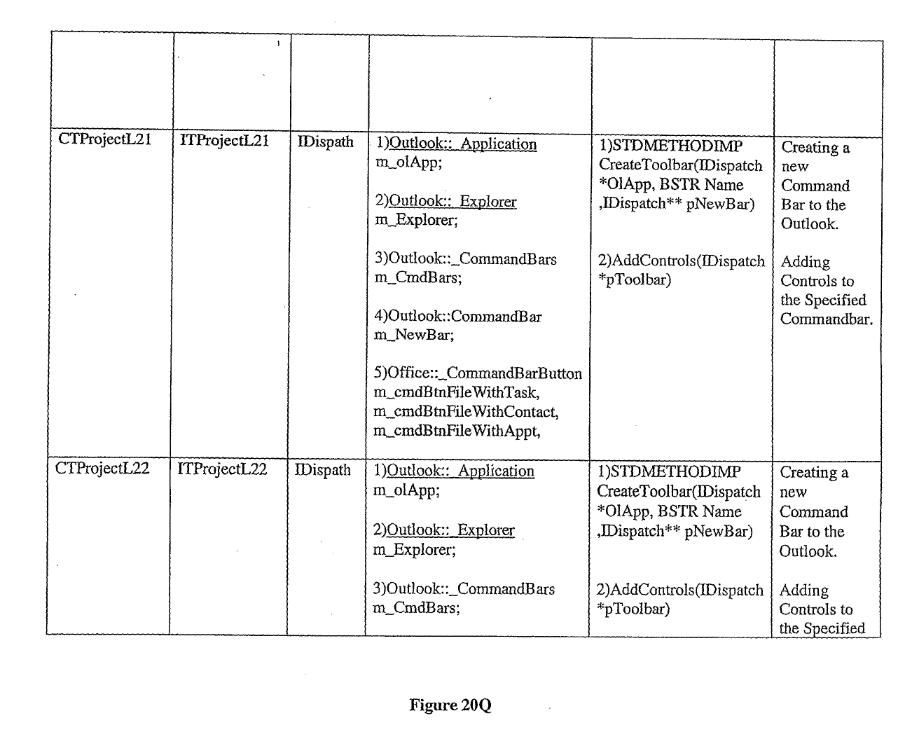

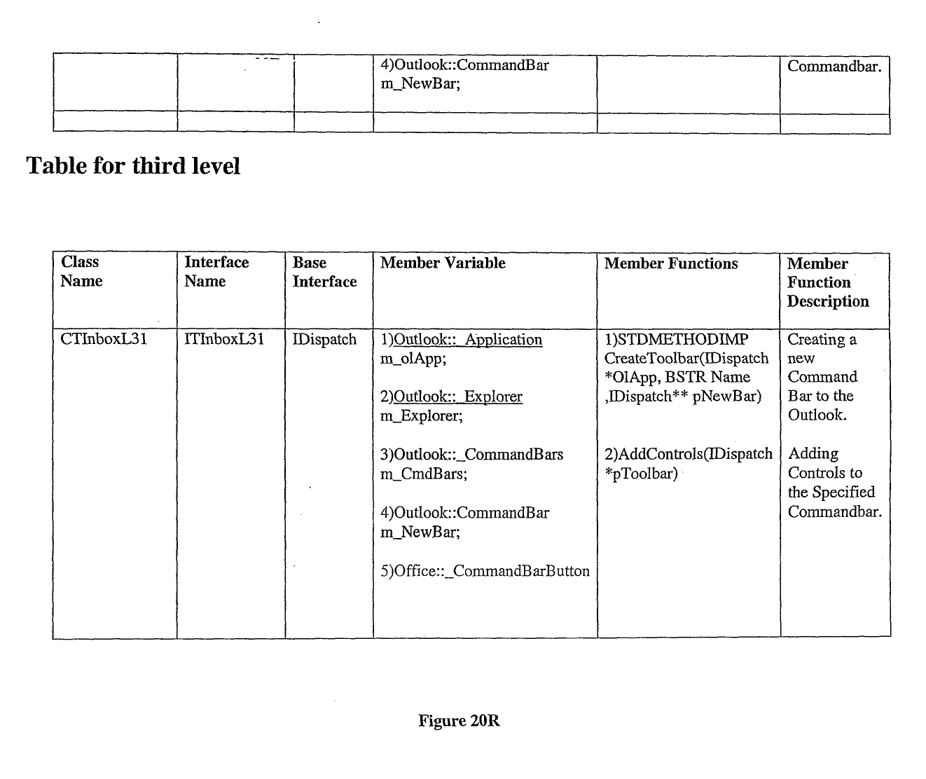

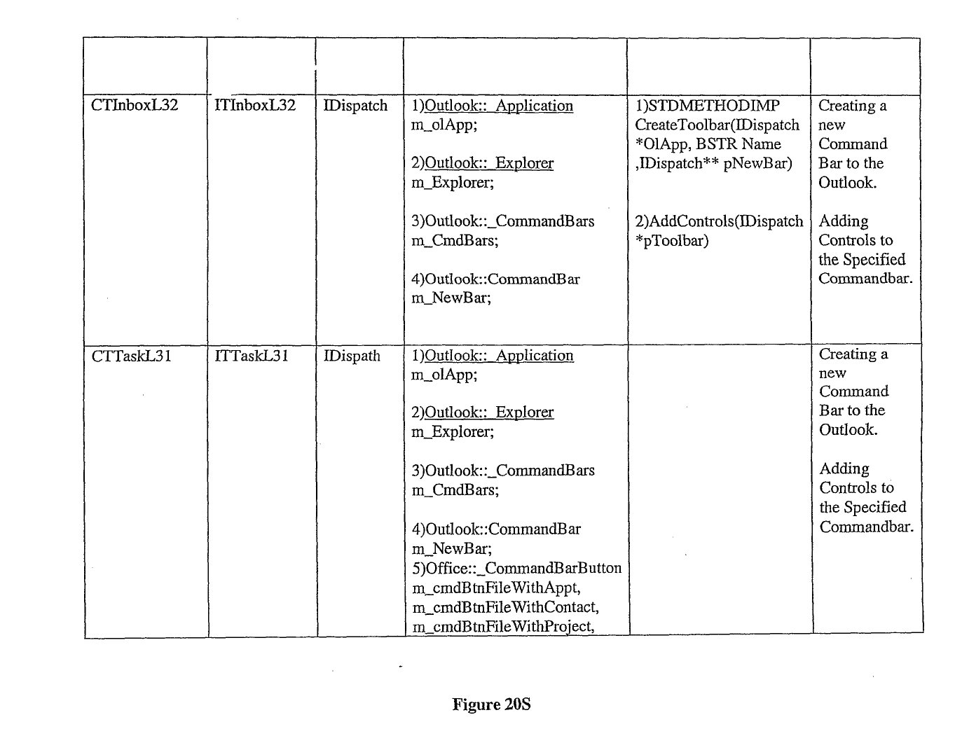

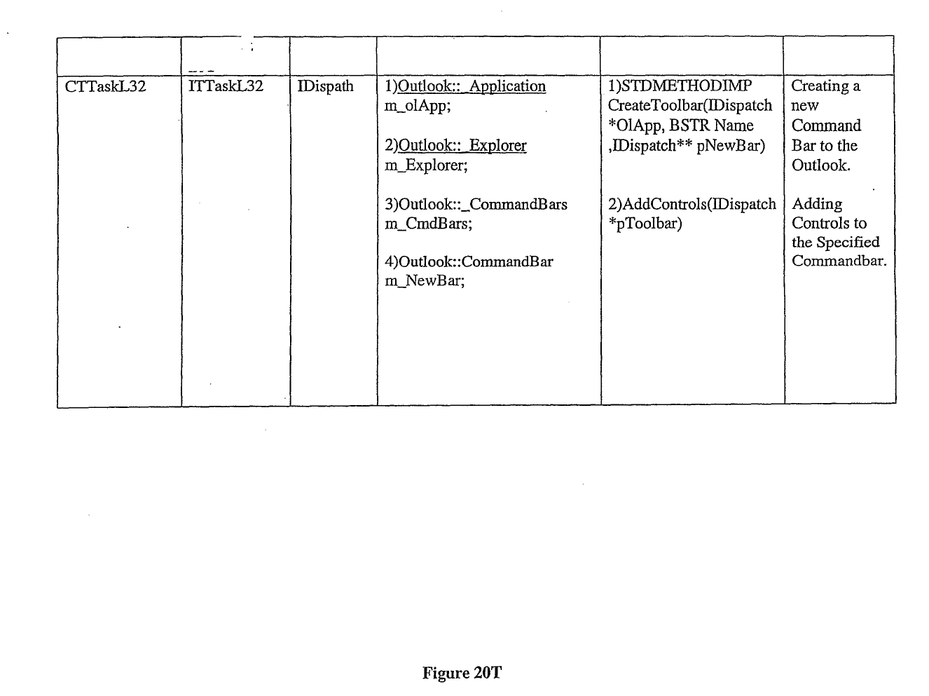

Referring now to FIGS. 1 to 18, the operation of the Applicant's preferred embodiment will now be described in more detail.

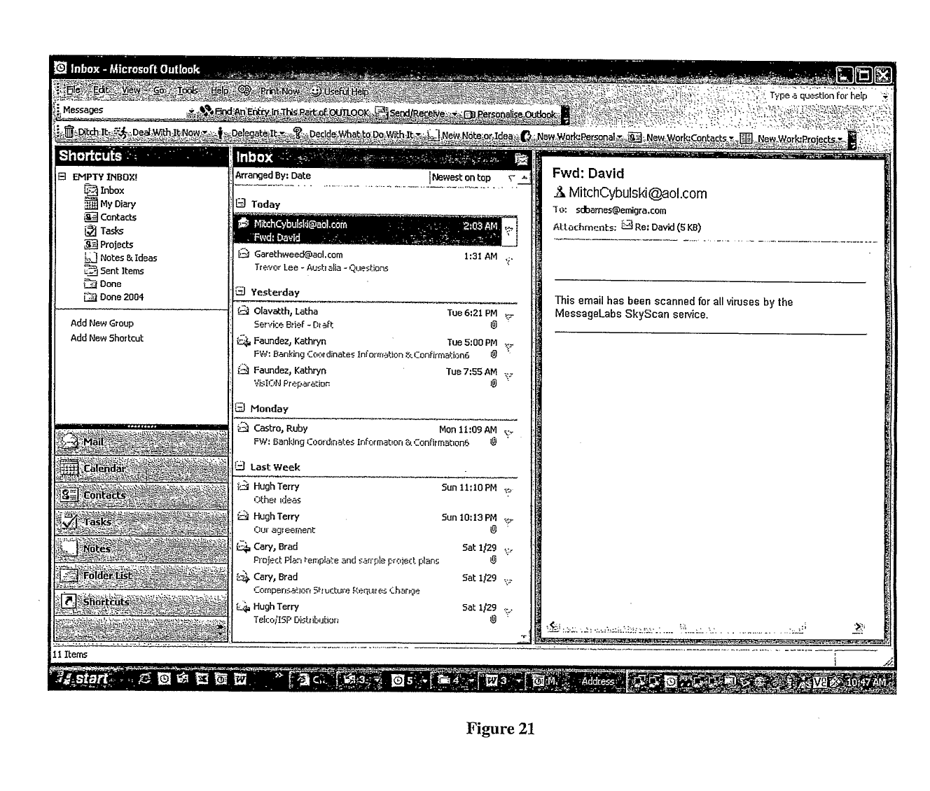

Firstly, the user initiates the opening of Microsoft Outlook 1. As Microsoft Outlook opens it also searches for various dll files. In this case the Applicants are including a dll file called EMPTY INBOX which will be added in to Outlook as a COM Addin 2. This COM Addin will be responsible for loading and unloading of other components of the present system. For example once the main COM Addin is loaded, the system then immediately loads lnboxLv11 and lnboxLv12 together with MenuBar components which enable functions such as help and printing. As part of this process the toolbar is designed for the present system will also be loaded, which in this case includes loading Ditch It, Deal With It Now, Delegate It, and Decide What To Do With It as exemplified in FIG. 21.

In the preferred implementation the system will open in to the users Inbox. The user will have the option to process various mail items or alternatively to switch 3 from the Inbox folder. In this implementation the user can select their diary or calendar folder for, a task folder 5, contacts folder 6, projects folder 7, or a notes folder 8. If the user elects to process an mail item then they are able to select 16 various options from the Inbox. These options include Ditch It 17, Deal With It Now 18, Delegate It 19, Decide What To Do With It 20, and New Work Menus 24. If the user selects to Ditch It 17 then the system deletes the selected mail item. No further action 23 is required at this point and the user remains in the Inbox view.

Should the user elect to deal with the mail item immediately 18, then the user will need to determine whether they wish to reply to only the sender of the mail item or replay to all recipients 22. The system would then open a new mail item 25 which would be addressed to the appropriate persons. Similarly if the user wishes to delegate 19 a mail item to another person the system will open a new mail item with forward functionality 25 allowing the user to select who to forward the matter to.

Once a new mail item is open the user is able to add any further commentary as desired, and if necessary select additional mail item addresses known to receive the mail item. The user would then send 10 the mail item to the recipients. In the preferred implementation the user would then be prompted to determine what action 11 to take regarding the original mail item. The user would be able to select 12 whether to Ditch the original mail item and thus delete 13 the original mail item, to mark the mail as done and thereby move 14 the original mail item to the done folder, or to skip this step and simply return 15 the user to the Inbox. Once the user selects 16 a mail item from the Inbox, the user may then decide 20 what to do with that mail item. In the preferred arrangement the user would be able to select 26 from a series of options including File As Done 27, Record New Idea 28 Create Task 29, Add to Watch List 30, Schedule An Appointment 36, or File With Another Matter 31. In each case of the current arrangement the system will attach a copy of the mail item to the function selected by the user. For example should the user schedule an appointment 36 then the system will create that new appointment 39 and also attach the mail item 42 to the appointment item. In this way should the user review the appointment they will be able to refer to the original email which instigated the action. Similarly, should the user elect to create a new task 29, then the system creates the task 34 and again attaches the mail item 41 to the task item. Once the mail item is attached to the appropriate function the system will then again prompt 45 user to either delete 46, move 47 or leave the email in the Inbox before returning the user to the Inbox.

The user also has the ability to attach 31 the mail item to an existing item. For example a task may have previously been defined by the user, and the user may now wish to attach a new mail item to that same task. In the preferred arrangement the system will display a dialogue box showing a new name for the mail item 49. In some arrangements the user wish to rename this item. The system will then open 50 the appropriate task or appointment while the function selected by the user and attach 51 the new mail item to the existing function. The user would then again be prompted as to what action the system should take with the original mail item before returning the user to the Inbox.

In preferred arrangements it will also be noted that in some circumstances it may be warranted to create a new idea, work contact 59, work project 60 or personal item 61 without necessarily receiving a new mail item. Such actions can be undertaken by the preferred embodiment of the present invention, and any functions created by this new work menu, would then be available for use within the system as a whole. For example if the user was to open a new project item 70, and a subsequent mail item was received by the user, then this new mail item could be filed 31 with the newly created project item.

The concept of Ditching It, Dealing With It, Delegating It or Deciding What To Do With It can also be extended to the remaining features of Microsoft Outlook, and not just the mail Inbox. For example if the user was to select their diary or calendar folder 4, the user would then be able to select 85 any particular appointment and then either Ditch 86 the appointment Deal 87 with the appointment now by opening 91 the appointment delegating 88 the appointment by opening a new mail item 93 to forward the appointment to another person, or Deciding 89 what to do with the appointment.

If the user was to open the tasks folder 5 then the user could select 99 any task and either Ditch 100 the task by deleting the task 104 from the task folder, dealing 101 with the task now, delegating 102 the task by another mail item 106, or deciding 103 what to do with the task item.

The user may also select the contacts folder 6 and upon select 113 any particular contact, again decide whether to ditch 114 the contact, deal with the contact now 115, delegate the contact 116, or decide 117 what to do with the contact. Should the user select the projects folder 7 then again the user can select 127 any particular project and then determine whether to ditch 128 the project, deal with the project now 129 delegate 130 the project or decide what to do with the project 131. Similarly, if the user selects the notes folder 8 then the user may select any note 141 from the notes folder and then either delete the note 142, deal with the note now 143, delegate the note 144 or decide what to do with the note 145.

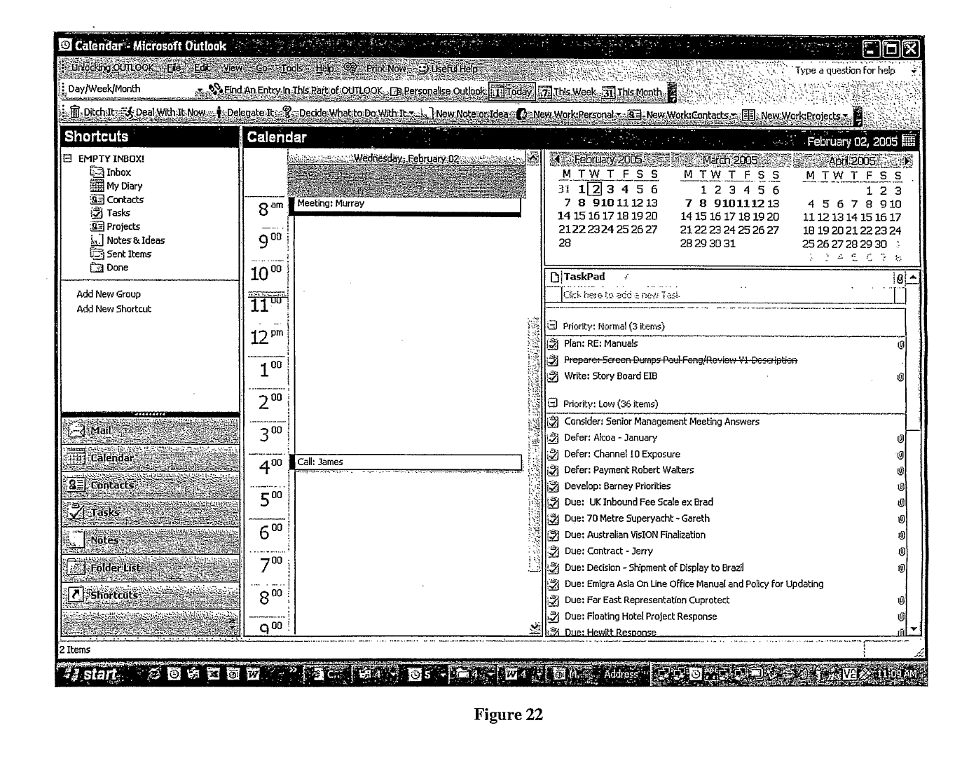

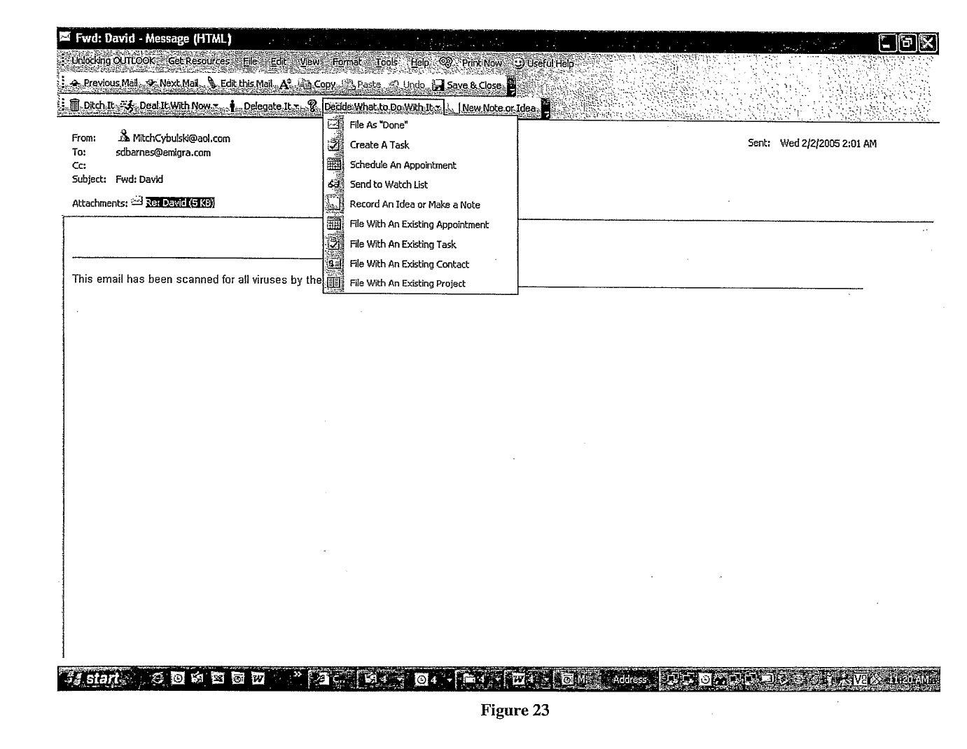

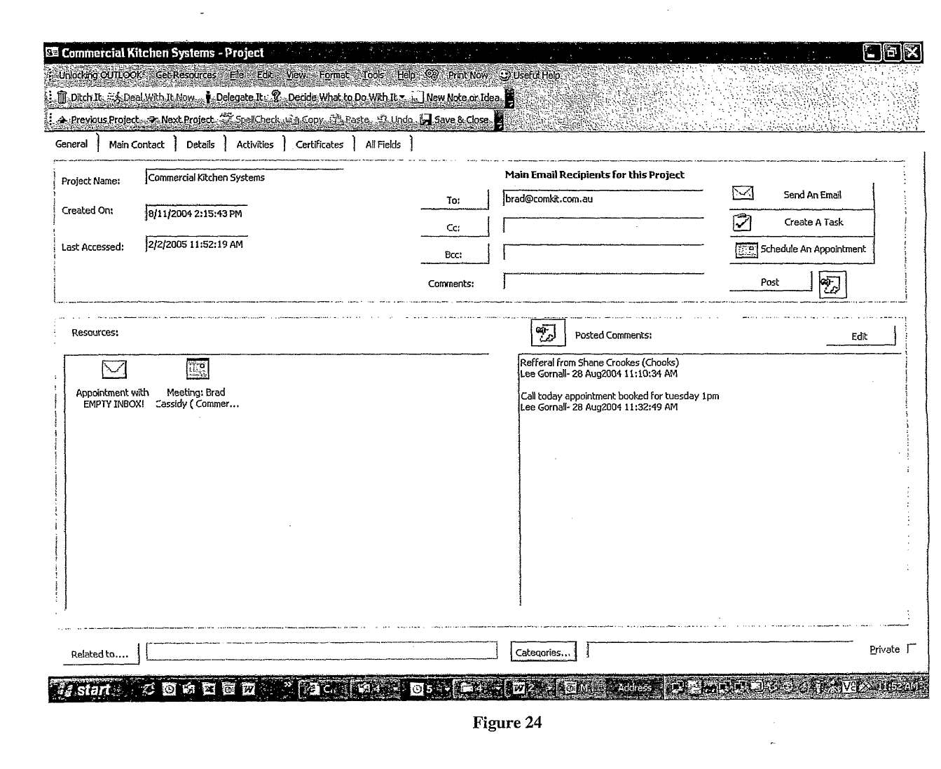

Implementation of the present invention can been seen exemplified in FIGS. 21 to 25 which shows sample screen shots. By modifying Microsoft Outlook as detailed herein and more efficient and more intuitive system as being developed. The main MenuBar which has been added in this arrangement can be seen on FIG. 21 with the various icons. The user can therefore select to either Ditch It, Deal With It Now, Delegate It, or Decide What To Do With It. It can be seen in the example of FIG. 21 that the user can also select to create a new note or idea, create new work which is personal, new contacts or new work projects. If the user was to select a calendar or diary view as shown in FIG. 22 then again this main MenuBar is available for the user. From FIG. 23 the various options available to the user when they select Decide What To Do With It can be seen. The labelling of these options and the functionality as described previously does allow for a more intuitive operation of Microsoft Outlook.

In the preferred arrangement the above system will be made available through the provision of a COM Addin to Microsoft Outlook. However virtually configures the main toolbar, and then configures an open items toolbar. In order to configure the main toolbar, the system should undertake the following eight steps

Step 1:

Make a list for ““Template Outlook Setting's” ” toolbar controls.
Open OutLook;
Reset and hide all Toolbars;
Create a new folder for contact items and name it “Projects”;
Make a new Group called ““Work From An EMPTY INBOX!” ”;
Create the “Projects” folder's shortcut in the new Group and rename to ““Template Outlook Setting””'s setting;

Step 2:
Select a folder; (for example: TaskFolder)

Step 3:
Get a control from ““Template Outlook Setting's” ” control list;

Step 4:
Find this control (button or other control) from the invention's Outlook Setting Template in Outlook's controls.
a). if this control is Visible then rename it to ““Template Outlook Setting's” ” command/setting; for example: “Help”->“Microsoft Help”;
b). if this control is not visible then copy it to “MainBar” and set it to visible and name it;
c). if this control cannot be found or it can be found but cannot be set to visible then create a new control in “MainBar”;
d). set this control's tag=0, indicating proprietary Template Outlook control.

Step 5:
Loop step 3 and step 4 until all the controls have been set;

Step 6:
Loop step 2-5 until all folders have been set.

Step 7:
Reset these controls' index.

Step 8:
Correct any controls that show incorrect location or visible status.

Once the main toolbar has been configured the system then sets the open items window toolbar. Ideally this is achieved using the following steps:

Step 1:
Make a list for ““Template Outlook Setting's” ” open item window's main toolbar controls;
Make a list for ““Template Outlook Setting's” ” open item window's standard toolbar controls;
Reset and hide all Toolbars where possible;

Step 2:
Go to a folder;
Open the first item; if no item, create a new item;
(For example: TaskFolder, open the first task, if no existing task, then open a new task window)
then do flow step 1 on this window;

Step 3:
Set the main toolbar first, so set current toolbar=main toolbar;
Get a control from ““Template Outlook Setting's” ” open item window's required current toolbar control list;

Step 4:
Find this control (button or other control) from the invention Outlook Setting Template in Outlook's controls;
a). if this control is Visible then rename it to ““Template Outlook Setting's” ” command/setting;
b). if this control is not visible then copy it to the current toolbar and set it as visible and name it;
c). if this control cannot found or it can be found but cannot set to visible then create a new control in the current toolbar;
d). set this control's tag=0, indicating proprietary Template Outlook control;

Step 5:
Loop step 3 and step 4 until all the controls have been set;

Step 6:
Loop step 3 and step 4 and step 5, setting current toolbar as standard toolbar;

Step 7:
Loop step 2-6 until all folders' open item windows have been set;

Step 8:
Reset these controls' index;

Step 9:
Correct any controls that show incorrect location or visible status

The system to configure Outlook may be created using methodology detailed in the present specificiation. This system has been designed for versions of Microsoft Outlook greater than Outlook 97.

Returning to FIGS. 21 to 25, the shortcut icons which are preferably made available once the system has customised Outlook are shown. It is noted that in the Applicant's preferred arrangement Calendar has been renamed to My Diary. Whilst renaming is not necessary, doing so does assist in the user's understanding of the system. Similarly, if desired the other various programs or components of Outlook may also be renamed. It is also noted that the present system renames Notes to read Notes & Ideas. Further the system does create a new folder called Projects which is used to store such work. The system also creates a new folder called Done which is used to store emails which are to be filed for future reference. Once configured in accordance with the present system, if a user was to select My Diary a screen as exemplified in FIG. 22 may be seen. It can be seen that the ideal shortcuts are provided on the left hand side of the screen enabling the user to easily switch between the various components of the system. An expanded one day calendar view is provided towards the centre of the screen easily showing the user any appointments that may have been scheduled for that day. A three month forward calendar is also ideally provided. Details of the work required for the day and priority may be shown below the forward calendar.

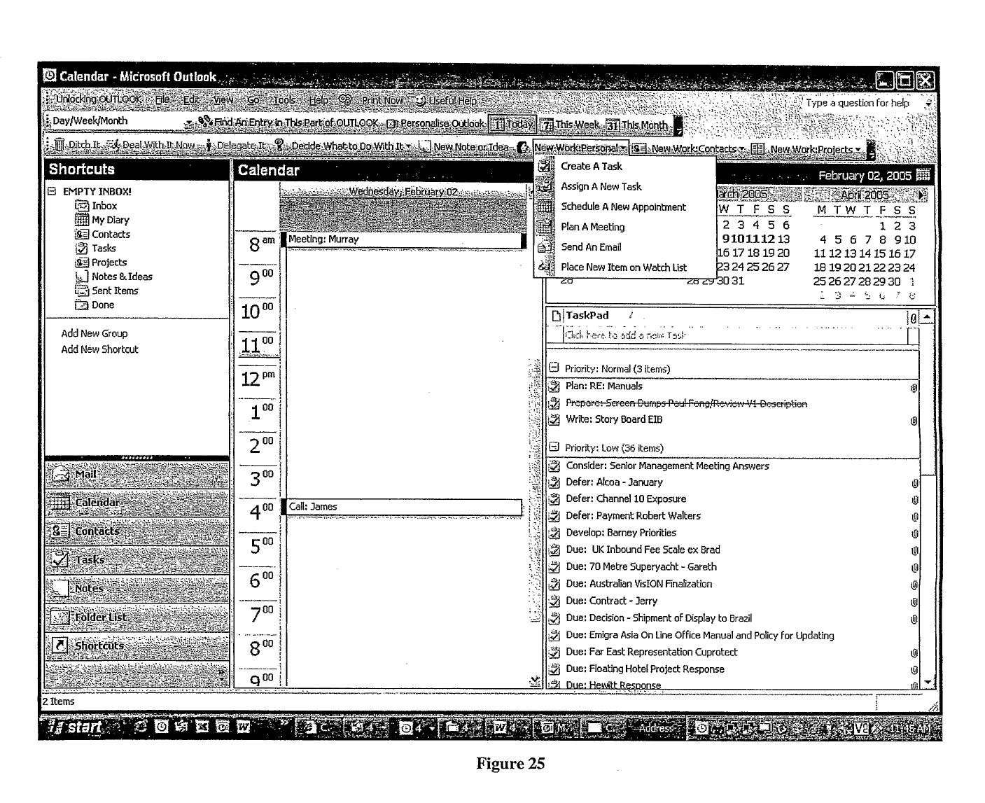

The system does add a new special toolbar across the top of the screen which reflects the principles of the system which seeks to always perform one of four actions for each incoming email and to readily access their Project and Contact work. There is also a discrete series of menu items which allow a user of the system to access the key organizational features of Outlook all in one place. This toolbar, in its totality, enables the user to quickly process each incoming email and to organize the balance of his work not originating from email in a cohesive, intuitive manner as shown in FIG. 25.

The four main options presented to users are shown on FIG. 23. Here it can be seen that the options to “Deal With It Now”, “Decide What To Do With It”, “Delegate it”, or “Ditch It” are shown. If a user was to open an incoming email as shown in FIG. 23, they would then upon reading the email need to determine which of the four options should be proceeded with.

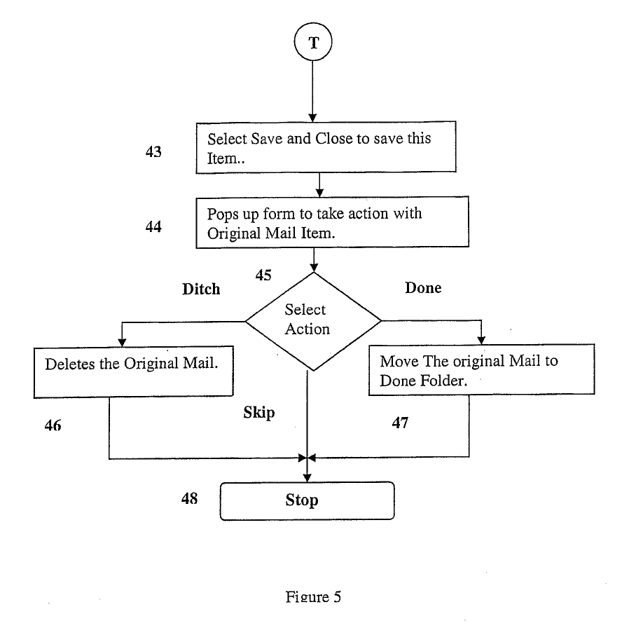

Once the present system has customised the user's Microsoft Outlook such that it is configured in accordance with the premise of the present invention, the user will be able to improve their efficiency and productivity by following the simple principles on which the present invention is based. That is, the user is encouraged to progressively work through the emails in the Inbox, and undertake one of four tasks in respect of each email. This is exemplified in FIG. 5. Here it can be seen that for each item in the Inbox, the user is faced with four options, they may deal with the email immediately if the work matter must be attended to immediately. Alternatively, they may schedule and organise the work for a later time, delegate the work to another person, or assimilate the contents of the email and delete the email. Should the user proactively schedule the work to be done at a later date, they will be able to make a new calendar entry if a meeting is required, or make a task entry should the user be required to do the task at a later date. This task may be given a priority of Normal or Low, depending on the active or passive nature of the matter. The user may also note an idea or file an email together with a previously scheduled appointment, task or project or contact item.

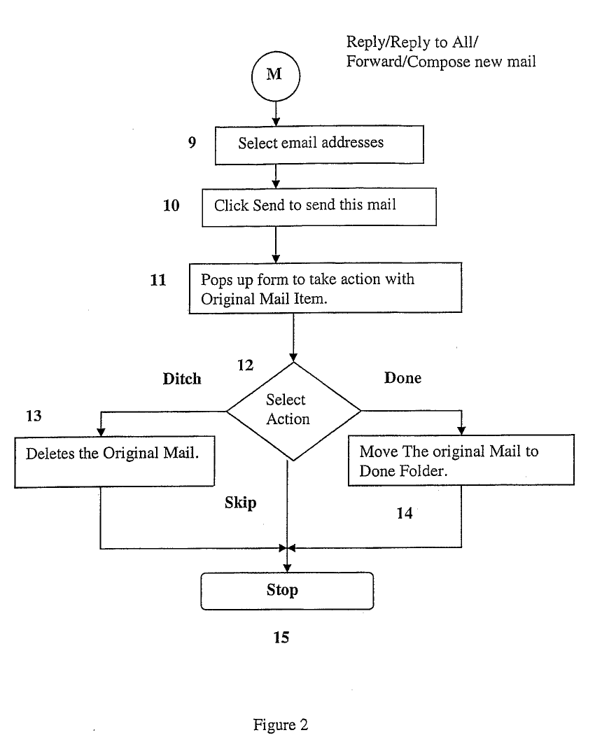

The user should also be encouraged to use a similar system for sent emails at the end of a day The overall process of the preferred implementation once the user's Outlook is configured in accordance with the present invention is shown in FIG. 2. In FIG. 2 it can be seen that the user reviews each email in their Inbox, handles the email in accordance with the outline of FIG. 1, and then prioritises this work such that it is scheduled and organised throughout the day. Similarly, the user may review each of their sent emails at the end of the day and again prioritise and follow up as necessary. This arrangement is based on the premise that the user should endeavour to maintain an empty Inbox and ensure that emails and work are scheduled and categorised appropriately.

The present system enables Microsoft Outlook to be configured in such a way that a user will be able to more optimally manage their email inbox, and thereby enable the user to better control their own working environment.

1. A COMM Addin for Microsoft outlook, said COMM Addin adding a plurality of menu buttons to at least one page of Microsoft outlook viewable on a users screen, said menu buttons operable by said user, such that when said user receives a mail item in said users inbox operation of one said button enables said user to reply to the mail item, forward the mail item, or create a new item entry and said mail item is respectively copied to said reply, forwarded message or new item entry, and further wherein said mail item is removed from said inbox.

2. A COMM Addin as claimed in claim 1 wherein said new item includes a calendar entry, a note, a task, a project or a contact.

3. A COMM Addin as claimed in claim 1 wherein said buttons are operable from a home page of said Microsoft outlook.

4. A COMM Addin as claimed in claim 1 wherein said button further automatically relabels said reply, forwarded message or new item entry.

5. A system for customizing Microsoft outlook including the addition of a plurality of menu buttons to at least one page of Microsoft outlook viewable on a users screen, said menu buttons operable by said user, such that when said user receives a mail item in said users inbox operation of one said button enables said user to reply to the mail item, forward the mail item, or create a new item entry and said mail item is respectively copied to said reply, forwarded message or new item entry, and further wherein said mail item is removed from said inbox.

6. A system as claimed in claim 5 wherein said new item includes a calendar entry, a note, a task, a project or a contact.

7. A system as claimed in claim 5 wherein said buttons are operable from a home page of said Microsoft outlook.

8. A system as claimed in claim 5 wherein said button further automatically relabels said reply, forwarded message or new item entry.
